(19) United States
(12) Patent Application Publication
(10) Pub. No.: US 2024/0121830 A1
(43) Pub. Date: Apr. 11, 2024

(54) RACH OCCASION REPETITION AND PRACH FORMAT SELECTION BASED ON DEVICE TYPE IN NTN

(71) Applicant: QUALCOMM Incorporated, San Diego, CA (US)

(72) Inventors: Liangping MA, San Diego, CA (US); Xiao Feng WANG, San Diego, CA (US); Hung Dinh LY, San Diego, CA (US); Gokul SRIDHARAN, Sunnyvale, CA (US); Jun MA, San Diego, CA (US); Ayan SENGUPTA, San Diego, CA (US); Alberto RICO ALVARINO, San Diego, CA (US); Bharat SHRESTHA, San Diego, CA (US); Umesh PHUYAL, San Diego, CA (US); Peter GAAL, San Diego, CA (US); Juan MONTOJO, San Diego, CA (US); Wanshi CHEN, San Diego, CA (US); Huilin XU, Temecula, CA (US); Yiqing CAO, Beijing (CN)

(21) Appl. No.: 18/270,393

(22) PCT Filed: Mar. 22, 2021
(86) PCT No.: PCT/CN2021/082022

§ 371 Date: Jun. 29, 2023

(51) Int. Cl. H04W 74/0833; H04B 17/318; H04W 72/1268; H04W 74/08

(52) U.S. Cl. CPC H04W 74/0833; H04B 17/328; H04W 72/1268; H04W 74/0866

(57) ABSTRACT

RACH occasion repetition and PRACH format selection in an NTN are disclosed. The base station may determine, based on at least one beam, a first PRACH configuration for at least one first UE and a second PRACH configuration for at least one second UE. The base station may transmit, to at least one of the at least one first UE or the at least one second UE, an indication of the first PRACH configuration and the second PRACH configuration. The UE, based on whether it is a first UE or a second UE, may select, based on the received indication, the first PRACH configuration or the second PRACH configuration for at least one beam. The UE may initiate, via the at least one beam, a RACH procedure for the selected first PRACH configuration or the selected second PRACH configuration.

### BACKGROUND

### Technical Field

The present disclosure relates generally to communication systems, and more particularly, to random access channel (RACH) occasion repetition in anon-terrestrial network (NTN).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive, from at least one base station, an indication of a first physical random access channel (PRACH) configuration and a second PRACH configuration. The first PRACH configuration may include a first RACH occasion (RO) configuration and a first PRACH format. The second PRACH configuration may include a second RO configuration and a second PRACH format. The apparatus may select, based on the received indication, the first PRACH configuration or the second PRACH configuration for at least one beam. The apparatus may initiate, via the at least one beam, a RACH procedure for the selected first PRACH configuration or the selected second PRACH configuration.

In an aspect of the disclosure, a method, a computer-readable medium, and an apparatus are provided. The apparatus may be a base station. The apparatus may determine, based on at least one beam, a first PRACH configuration for at least one first UE and a second PRACH configuration for at least one second UE. The first PRACH configuration may include a first RO configuration and a first PRACH format. The second PRACH configuration may include a second RO configuration and a second PRACH format. The apparatus may transmit, to at least one of the at least one first UE or the at least one second UE, an indication of the first PRACH configuration and the second PRACH configuration. The apparatus may monitor, via the at least one beam, for a PRACH sequence from at least one of the at least one first UE or the at least one second UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example network architecture capable of supporting satellite access using 5G NR.

FIG. 5 illustrates an example network architecture capable of supporting satellite access using 5G NR.

FIG. 6 is an example diagram illustrating PRACH formats.

FIG. 7 is a call flow diagram illustrating a method of wireless communication.

FIG. 8 is a diagram illustrating examples of RACH occasion repetition and PRACH format configuration.

FIG. 9 is a diagram illustrating examples of RACH occasion repetition and PRACH format configuration.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

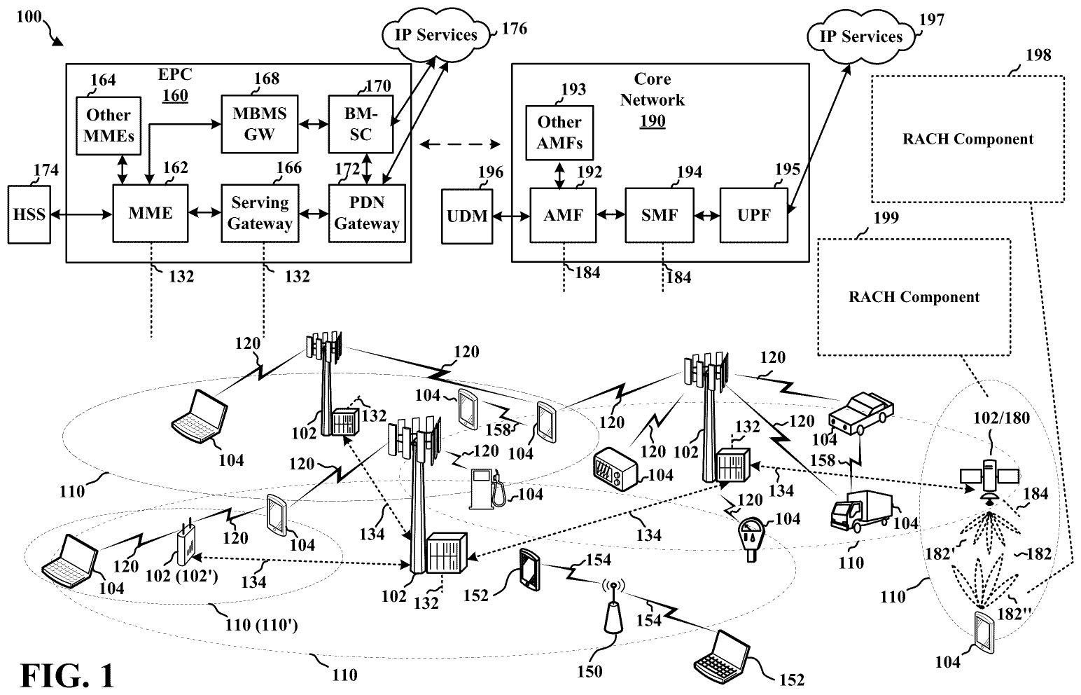

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from abase station 102 to a UE 104. The communication links 120 may use multiple-input and multiple-output (IMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and aUser Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a RACH component 198 that may be configured to receive, from at least one base station, an indication of a first PRACH configuration and a second PRACH configuration. The first PRACH configuration may include a first RO configuration and a first PRACH format. The second PRACH configuration may include a second RO configuration and a second PRACH format. The RACH component 198 may be further configured to select, based on the received indication, the first PRACH configuration or the second PRACH configuration for at least one beam. The RACH component 198 may be further configured to initiate, via the at least one beam, a RACH procedure for the selected first PRACH configuration or the selected second PRACH configuration. In certain aspects, the base station 180 may include a RACH component 199 that may be configured to determine, based on at least one beam, a first PRACH configuration for at least one first UE and a second PRACH configuration for at least one second UE. The first PRACH configuration may include a first RO configuration and a first PRACH format. The second PRACH configuration may include a second RO configuration and a second PRACH format. The RACH component 199 may be further configured to transmit, to at least one of the at least one first UE or the at least one second UE, an indication of the first PRACH configuration and the second PRACH configuration. The RACH component 199 may be further configured to monitor, via the at least one beam, for a PRACH sequence from at least one of the at least one first UE or the at least one second UE. Although the following description may be focused on 5G NR, the concepts described herein may be applicable to other similar areas, such as LTE, LTE-A, CDMA, GSM, and other wireless technologies.

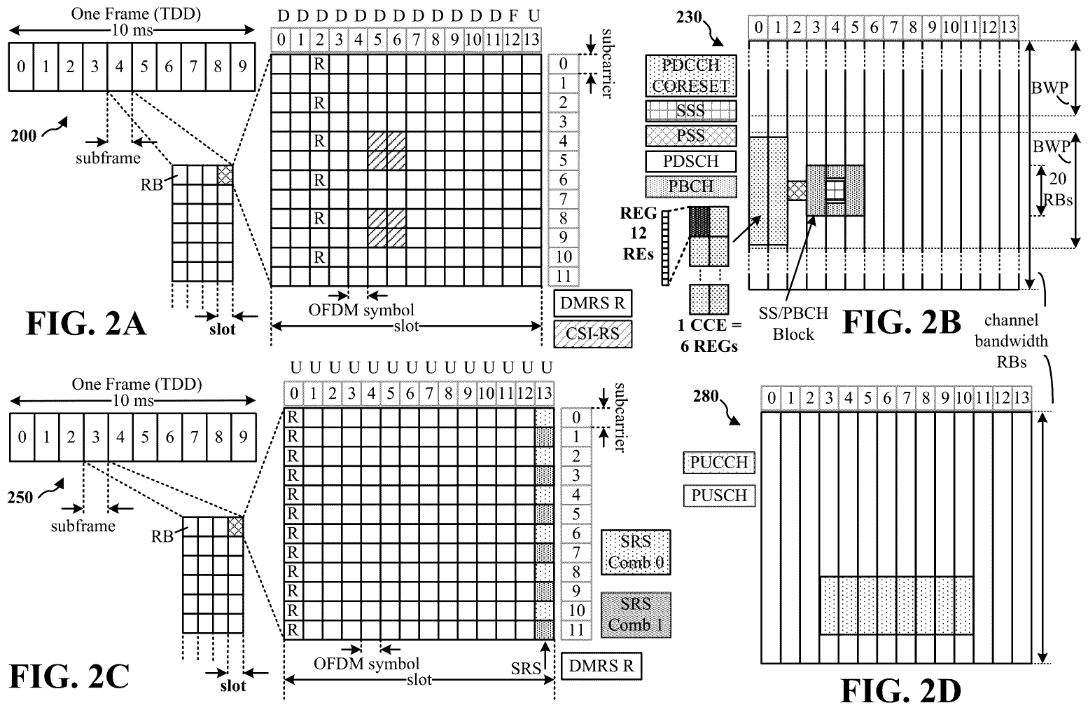

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 29 slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PI), a rank indicator (RI), and hybrid automatic repeat request (HARQ) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

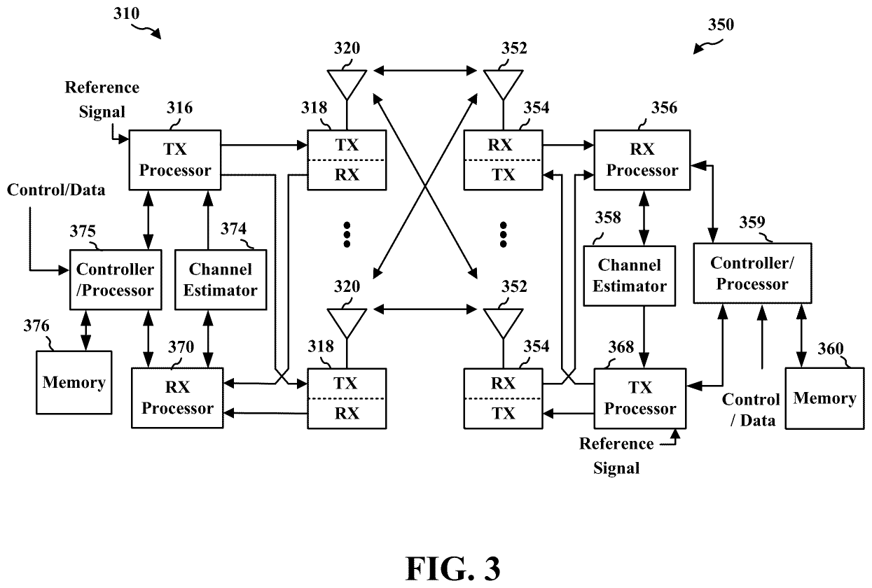

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

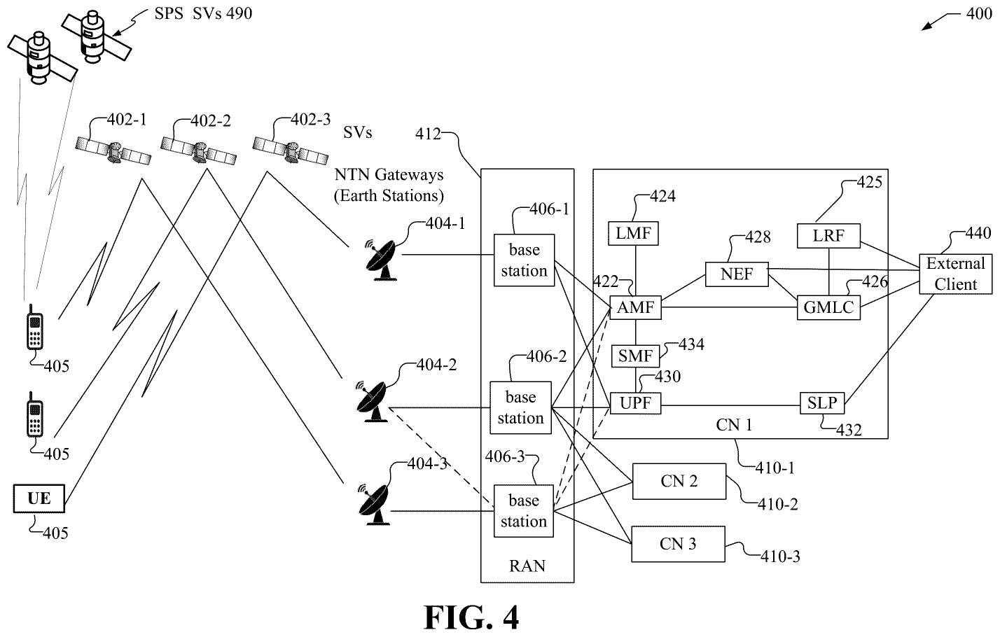

FIG. 4 illustrates an example network architecture 400 capable of supporting satellite access, e.g., using 5G NR. Although the aspects are described using the example of 5G NR, the concepts presented herein may also be applied for other types of core networks. FIG. 4 illustrates a network architecture with transparent (bent-pipe) SVs. A transparent SV may implement frequency conversion and a radio frequency (RF) amplifier in both UL and DL directions and may correspond to an analog RF repeater. A transparent SV, for example, may receive UL signals from all served UEs and may redirect the combined signals DL to an earth station without demodulating or decoding the signals. Similarly, a transparent SV may receive an UL signal from an earth station and redirect the signal DL to served UEs without demodulating or decoding the signal. However, the SV may frequency convert received signals and may amplify and/or filter received signals before transmitting the signals.

The network architecture 400 comprises a number of UEs 405, a number of SVs 402-1 to 402-3 (collectively referred to herein as SVs 402), a number of Non-Terrestrial Network (NTN) gateways 404-1 to 404-3 (collectively referred to herein as NTN gateways 404) (sometimes referred to herein simply as gateways 404, earth stations 404, or ground stations 404), a number of base stations (e.g., gNBs) capable of communication with UEs via SVs 402 referred to herein as simply as satellite base stations 406-1 to 406-3 (collectively referred to herein as base stations 406) that are part of an RAN 412 (e.g., an NG-RAN). The base stations 406 may correspond to the base station 310 in FIG. 3. The network architecture 400 is illustrated as further including components of core networks 410-1 to 410-3 (collectively referred to herein as CNs 410). In some aspects, the CNs 410 may include a number of Fifth Generation (5G) networks including 5G Core Networks (5GCNs) and may correspond to the core network 190 described in connection with FIG. 1. The CNs 410 may be public land mobile networks (PLMNs) that may be located in the same country or in different countries. FIG. 4 illustrates various components within CN1 410-1 that may operate with the RAN 412. It should be understood that CN2 410-2 and other CNs may include identical, similar, or different components and associated RANs, which are not illustrated in FIG. 4 in order to avoid unnecessary obfuscation. In some aspects, the CNs may be 5GCNs, a 5G network may also be referred to as an NR network; RAN 412 may be referred to as an NG-RAN, a 5G RAN or as an NR RAN; and CN 410 may be referred to as a 5G CN or an NG core network (NGC).

The network architecture 400 may further utilize information from SVs 490 for Satellite Positioning System (SPS) including GNSS like Global Positioning System (GPS), GLObal NAvigation Satellite System (GLONASS), Galileo or Beidou or some other local or regional SP S, such as Indian Regional Navigation Satellite System (IRNSS), European Geostationary Navigation Overlay Service (EGNOS), or Wide Area Augmentation System (WAAS), all of which are sometimes referred to herein as GNSS. It is noted that SVs 490 act as navigation SVs and are separate and distinct from SVs 402, which act as communication SVs. However, it is not precluded that some of SVs 490 may also act as some of SVs 402 and/or that some of SVs 402 may also act as some of SVs 490. In some implementations, for example, the SVs 402 may be used for both communication and positioning. Additional components of the network architecture 400 are described below. The network architecture 400 may include additional or alternative components.

Permitted connections in the network architecture 400 having the network architecture with transparent SVs illustrated in FIG. 4 may allow a base station 406 to access multiple earth stations 404 and/or multiple SVs 402. A base station 406, e.g., illustrated by base station 406-3, may also be shared by multiple CNs 410 (e.g., all of CN1 410-1 through CN3 410-3), and an earth station 404, e.g., illustrated by earth station 404-2, may be shared by more than one base station 406.

FIG. 4 provides a generalized illustration of various components, any or all of which may be utilized as appropriate, and each of which may be duplicated or omitted, as necessary. Specifically, although three UEs 405 are illustrated, it will be understood that many UEs (e.g., hundreds, thousands, millions, etc.) may utilize the network architecture 400. Similarly, the network architecture 400 may include a larger (or smaller) number of SVs 490, SVs 402, earth stations 404, base stations 406, RAN 412, CNs 410, external clients 440, and/or other components. The illustrated connections that connect the various components in the network architecture 400 include data and signaling connections which may include additional (intermediary) components, direct or indirect physical and/or wireless connections, and/or additional networks. Furthermore, components may be rearranged, combined, separated, substituted, and/or omitted, depending on desired functionality.

While aspects of FIG. 4 illustrate a 5G-based network, similar network implementations and configurations may be used for other communication technologies, such as 3G, 4G LTE, etc.

The UE 405 may comprise and/or be referred to as a device, a mobile device, a wireless device, a mobile terminal, a terminal, a mobile station (MS), a Secure User Plane Location (SUPL) Enabled Terminal (SET), or by some other name. Moreover, UE 405 may correspond to a cellphone, smartphone, laptop, tablet, PDA, tracking device, navigation device, IoT device, or some other portable or moveable device. Typically, though not necessarily, the UE 405 may support wireless communication using one or more Radio Access Technologies (RATs) such as using Global System for Mobile communication (GSM), CDMA, Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G NR (e.g., using the RAN 412 and CN410), etc. The UE405 may also support wireless communication using a Wireless Local Area Network (WLAN) which may connect to other networks (e.g., the Internet) using a Digital Subscriber Line (DSL) or packet cable for example. The UE 405 further supports wireless communications using space vehicles, such as SVs 402. The use of one or more of these RATs may allow the UE 405 to communicate with an external client 440 (via elements of CN 410 not shown in FIG. 4, or possibly via a Gateway Mobile Location Center (GMLC) 426).

The UE 405 may include a single entity or may include multiple entities such as in a personal area network where a user may employ audio, video and/or data I/O devices and/or body sensors and a separate wireline or wireless modem.

In some aspects, the UE 405 may support position determination, e.g., using signals and information from spacevehicles 490 in an SPS, such as GPS, GLONASS, Galileo or Beidou or some other local or regional SPS such as IRNSS, EGNOS or WAAS, all of which may be generally referred to herein as GNSS. Position measurements using SPS are based on measurements of propagation delay times of SPS signals broadcast from a number of orbiting satellites to a SPS receiver in the UE 405. Once the SPS receiver has measured the signal propagation delays for each satellite, the range to each satellite can be determined and precise navigation information including 3-dimensional position, velocity, and time of day of the SPS receiver can then be determined using the measured ranges and the known locations of the satellites. Positioning methods which may be supported using SVs 490 may include Assisted GNSS (A-GNSS), Real Time Kinematic (RTK), Precise Point Positioning (PPP) and Differential GNSS (DGNSS). Information and signals from SVs 402 may also be used to support positioning. In some aspects, the UE 405 may further support positioning using terrestrial positioning methods, such as Observed Time Difference of Arrival (OTDOA), Enhanced Cell ID (ECID), Round Trip signal propagation Time (RTT), multi-cell RTT, angle of arrival (AOA), angle of departure (AOD), time of arrival (TOA), receive-transmit transmission-time difference (Rx-Tx) and/or other positioning methods.

An estimate of a location of the UE 405 may be referred to as a location, location estimate, location fix, fix, position, position estimate, or position fix, and may be geographic, thus providing location coordinates for the UE 405 (e.g., latitude and longitude) which may or may not include an altitude component (e.g., height above sea level, height above or depth below ground level, floor level or basement level). Alternatively, a location of the UE 405 may be expressed as a civic location (e.g., as a postal address or the designation of some point or small area in a building such as a particular room or floor). A location of the UE 405 may also be expressed as an area or volume (defined either geographically or in civic form) within which the UE 405 is expected to be located with some probability or confidence level (e.g., 67%, 95%, etc.) A location of the UE 405 may further be a relative location comprising, for example, a distance and direction or relative X, Y (and Z) coordinates defined relative to some origin at a known location which may be defined geographically, in civic terms, or by reference to a point, area, or volume indicated on a map, floor plan, or building plan. In the description contained herein, the use of the term location may comprise any of these variants unless indicated otherwise. When computing the location of a UE, local x, y, and possibly z coordinates may be solved, and then, if needed, the local coordinates may be converted into absolute coordinates (e.g., coordinates for latitude, longitude and altitude above or below mean sea level).

In other aspects, the UE may not include a position or location capabilities, or it may be preferable for the UEto avoid at least some of the processing related to position or location determination.

The UEs 405 are configured to communicate with CNs 410 via the SVs 402, earth stations 404, and base stations 406. As illustrated by RAN 412, the RANs associated with the CNs 410 may include one or more base stations 406. The RAN 412 may further include a number of terrestrial base stations (not shown) that are not capable of communication with UEs via SVs 402 (not shown). Pairs of terrestrial and/or satellite base stations, e.g., terrestrial base stations and base stations 406-1 in RAN 412 may be connected to one another using terrestrial links—e.g., directly or indirectly via other terrestrial base stations or base stations 406 and communicate using an Xn interface. Access to the network may be provided to UEs 405 via wireless communication between each UE 405 and a serving base station 406, via an SV 402 and an earth station 404. The base stations 406 may provide wireless communications access to the CN 410 on behalf of each UE 405, e.g., using 5G NR. 5G NR radio access may also be referred to as NR radio access or as 5G radio access and may be as defined by the 3GPP, for example.

Base stations (BSs) in the RAN 412 shown in FIG. 4 may also or instead include a next generation evolved Node B, also referred to as an ng-eNB. An ng-eNB may be connected to one or more base stations 406 and/or terrestrial base stations in RAN 412—e.g., directly or indirectly via other base stations 406, terrestrial base stations and/or other ng-eNBs. An ng-eNB may provide LTE wireless access and/or evolved LTE (eLTE) wireless access to a UE 405.

A base station 406 may be referred to by other names such as a gNB or a “satellite node” or “satellite access node.” The base stations 406 are not the same as terrestrial gNBs, but may be based on a terrestrial gNB with additional capability. For example, a base station 406 may terminate the radio interface and associated radio interface protocols to UEs 405 and may transmit DL signals to UEs 405 and receive UL signals from UEs 405 via SVs 402 and earth stations (ESs) 404. A base station 406 may also support signaling connections and voice and data bearers to UEs 405 and may support handover of UEs 405 between different radio cells for the same SV 402, between different SVs 402, and/or between different base stations 406. Base stations 406 may be configured to manage moving radio beams (for LEO SVs) and associated mobility of UEs 405. The base stations 406 may assist in the handover (or transfer) of SVs 402 between different earth stations 404, different base stations 406, and between different countries. The base stations 406 may hide or obscure specific aspects of connected SVs 402 from the CN 410, e.g., by interfacing to a CN 410 in the same way or in a similar way to a terrestrial base stations, and may avoid a CN 410 from having to maintain configuration information for SVs 402 or perform mobility management related to SVs 402. The base stations 406 may further assist in sharing of SVs 402 over multiple countries. The base stations 406 may communicate with one or more earth stations 404, e.g., as illustrated by base station 406-2 communicating with earth stations 404-2 and 404-1. The base stations 406 may be separate from earth stations 404, e.g., as illustrated by base stations 406-1 and 406-2, and earth stations 404-1 and 404-2. The base stations 406 may include or may be combined with one or more earth stations 404, e.g., using a split architecture. For example, with a split architecture, a base station 406 may include a Central Unit and an earth station may act as Distributed Unit (DU). A base station 406 may be fixed on the ground with transparent SV operation. In one implementation, one base station 406 may be physically combined with, or physically connected to, one earth station 404 to reduce complexity and cost.

The earth stations 404 may be shared by more than one base station 406 and may communicate with UE 405 via the SVs 402. An earth station 404 may be dedicated to just one SVO and to one associated constellation of SV 402 and hence may be owned and managed by the SVO. Earth stations 404 may be included within a base station 406, e.g., as a base station-DU within a base station 406, which may occur when the same SVO or the same MNO owns both the base station 406 and the included earth stations 404. Earth stations 404 may communicate with SVs 402 using control and user plane protocols that may be proprietary to an SVO. The control and user plane protocols between earth stations 404 and SVs 402 may: (i) establish and release earth station 404 to SV 402 communication links, including authentication and ciphering; (ii) update SV software and firmware; (iii) perform SV Operations and Maintenance (O&M); (iv) control radio beams (e.g., direction, power, on/off status) and mapping between radio beams and earth station UL and DL payload; and (v) assist with handoff of an SV 402 or radio cell to another earth station 404.

As noted, while FIG. 4 depicts nodes configured to communicate according to 5G NR and LTE communication protocols for an NG-RAN 412, nodes configured to communicate according to other communication protocols may be used, such as, for example, an LTE protocol for an E-UTRAN or an IEEE 802.11x protocol for a WLAN. For example, in a 4G Evolved Packet System (EPS) providing LTE wireless access to UE 405, a RAN may comprise an E-UTRAN, which may comprise base stations comprising evolved Node Bs (eNBs) supporting LTE wireless access. A core network for EPS may comprise an EPC. An EPS may then comprise an E-UTRAN plus EPC, where the E-UTRAN corresponds to NG-RAN 412 and the EPC corresponds to CN 410 in FIG. 4. The methods and techniques described herein for support of a RAN location server function may be applicable to such other networks.

The base stations 406 and terrestrial base stations (if present in the NG-RAN 412) may communicate with an AMF 422 in a CN 410, which, for positioning functionality, may communicate with a Location Management Function (LMF) 424. For example, the base stations 406 may provide an N2 interface to the AMF 422. An N2 interface between a base station 406 and a CN 410 may be the same as an N2 interface supported between a base station and a CN 410 for terrestrial NR access by a UE 405 and may use the Next Generation Application Protocol (NGAP), e.g., as defined in 3GPP Technical Specification (TS) 38.413 between a base station 406 and the AMF 422. The AMF 422 may support mobility of the UE 405, including radio cell change and handover and may participate in supporting a signaling connection to the UE 405 and possibly data and voice bearers for the UE 405. The LMF 424 may support positioning of the UE 405 when the UE accesses the NG-RAN 412 and may support position procedures/methods such as A-GNSS, OTDOA, RTK, PPP, DGNSS, ECID, AOA, AOD, multi-cell RTT, and/or other positioning procedures including positioning procedures based on communication signals from one or more SVs 402. The LMF 424 may also process location services requests for the UE 405, e.g., received from the AMF 422 or from a GMLC 426. The LMF 424 may be connected to AMF 422 and/or to GMLC 426. In some embodiments, a node/system that implements the LMF 424 may additionally or alternatively implement other types of location-support modules, such as an Enhanced Serving Mobile Location Center (E-SMLC). It is noted that in some aspects, at least part of the positioning functionality (including derivation of a UE 405's location) may be performed at the UE 405 (e.g., using signal measurements obtained by UE 405 for signals transmitted by SVs 402, SVs 490, base stations and assistance data provided to the UE 405, e.g., by LMF 424).

The GMLC 426 may support a location request for the UE 405 received from an external client 440 and may forward such a location request to the AMF 422 for forwarding by the AMF 422 to the LMF 424. A location response from the LMF 424 (e.g., containing a location estimate for the UE 405) may be similarly returned to the GMLC 426 via the AMF 422, and the GMLC 426 may then return the location response (e.g., containing the location estimate) to the external client 440. The GMLC 426 is shown connected to the AMF 422 in FIG. 4 though in some implementations may be connected to both the AMF 422 and the LMF 424 and may support direct communication between the GMLC 426 and LMF 424 or indirection communications, e.g., via the AMF 422.

A Network Exposure Function (NEF) 428 may be included in CN 410, e.g., connected to the GMLC 426 and the AMF 422. In some implementations, the NEF 428 may be connected to communicate directly with the external client 440. The NEF 428 may support secure exposure of capabilities and events concerning 5GCN 410 and UE 405 to an external client 440 and may enable secure provision of information from external client 440 to CN 410.

A UPF 430 may support voice and data bearers for UE 405 and may enable UE 405 voice and data access to other networks such as the Internet. The UPF 430 may be connected to base stations 406 and terrestrial base stations. UPF 430 functions may include: external PDU session point of interconnect to a data network, packet (e.g., IP) routing and forwarding, packet inspection and user plane part of policy rule enforcement, QoS handling for user plane, downlink packet buffering, and downlink data notification triggering. UPF 430 may be connected to a Secure User Plane Location (SUPL) Location Platform (SLP) 432 to enable support of positioning of UE 405 using SUPL. SLP 432 may be further connected to or accessible from external client 440.

As illustrated, an SMF 434 connects to the AMF 422 and the UPF 430. The SMF 434 may have the capability to control both a local and a central UPF within a PDU session. SMF 434 may manage the establishment, modification, and release of PDU sessions for UE 405, perform IP address allocation and management for UE 405, act as a Dynamic Host Configuration Protocol (DHCP) server for UE 405, and select and control a UPF 430 on behalf of UE 405.

The external client 440 may be connected to the core network 410 via the GMLC 426 and/or the SLP 432, and in some implementations, the NEF 428. The external client 440 may optionally be connected to the core network 410 and/or to a location server, which may be, e.g., an SLP, that is external to CN 410, via the Internet. The external client 440 may be connected to the UPF 430 directly (not shown in FIG. 4) or through the Internet. The external client 440 may be a server, a web server, or a user device, such as a personal computer, a UE, etc.

A Location Retrieval Function (LRF) 425 may be connected to the GMLC 426, as illustrated, and in some implementations, to the SLP 432, e.g., as defined in 3GPP TSs 23.271 and 23.167. LRF 425 may perform the same or similar functions to GMLC 426, with respect to receiving and responding to a location request from an external client 440 that corresponds to a Public Safety Answering Point (PSAP) supporting an emergency call from UE 405. One or more of the GMLC 426, LRF 425, and SLP 432 may be connected to the external client 440, e.g., through another network, such as the Internet.

The AMF 422 may normally support network access and registration by UEs 405, mobility of UEs 405, including radio cell change and handover and may participate in supporting a signaling connection to a UE 405 and possibly data and voice bearers for a UE 405. The role of an AMF 422 may be to transfer an alert message along with a list of identifiers for fixed cells to one or more base stations 406 (and possibly terrestrial base stations) in the RAN 412, e.g., as determined using the identifiers for fixed tracking areas provided by CBCF 435. Here, and for normal operation, base stations 406 (and terrestrial base stations) may support wireless access using NR by UEs 405. The base stations, comprising the base stations 406 (and terrestrial base stations) broadcast the alert message (e.g., using a SIB12), and including possibly the target area shape, to UEs 405 in their respective coverage areas. The broadcast may occur in each fixed cell that is indicated to a base station in association with the alert message by an AMF 422. A base station 406 may map the fixed cells to radio cells controlled by the base station 406 in which the alert message is broadcast (e.g., using a SIB12).

Network architecture 400 may be associated with or have access to SVs 490 for a GNSS like GPS, GLONASS, Galileo or Beidou, or some other local or regional Satellite Positioning System (SPS) such as IRNSS, EGNOS or WAAS. UEs 405 may obtain location measurements for signals transmitted by SVs 490 and/or by base stations and access points such as eNBs, ng-eNB, gNB, and/or SVs 402 which may enable a UE 405 to determine a location estimate for UE 405 or to obtain a location estimate for UE 405 from a location server in CN 410, e.g., LMF 424. For example, UE 405 may transfer location measurements to the location server to compute and return the location estimate. UEs 405 (or the LMF 424) may obtain a location estimate for UE 405 using position methods such as GPS, A-GPS, A-GNSS, OTDOA, ECID, multi-cell RTT, WLAN positioning (e.g., using signals transmitted by IEEE 802.11 WiFi access points), sensors (e.g., inertial sensors) in UE 405, or some (hybrid) combination of these. A UE 405 may use a location estimate for the UE 405 to determine or help determine whether the UE 405 is in an impact area for a broadcast alert message.

As noted, while the network architecture 400 is described in relation to 5G technology, the network architecture 400 may be implemented to support other communication technologies, such as GSM, WCDMA, LTE, etc., that are used for supporting and interacting with mobile devices such asthe UE 405 (e.g., to implement voice, data, positioning, and/or other functionalities). In some such embodiments, the CN 410 may be configured to control different air interfaces. For example, in some embodiments, CN 410 may be connected to a WLAN, either directly or using a Non-3GPP InterWorking Function (N3IWF, not shown FIG. 4) in the 5GCN 410. For example, the WLAN may support IEEE 802.11 WiFi access for UE 405 and may comprise one or more WiFi APs. Here, the N3IWF may connect to the WLAN and to other elements in the CN 410 such as AMF 422.

Support of transparent SVs with the network architecture shown in FIG. 4 may impact the communication system as follows. The CN 410 may treat a satellite RAT as a new type of terrestrial RAT with longer delay, reduced bandwidth and higher error rate. Consequently, while there may be some impact to PDU session establishment and mobility management (MM) and connection management (CM) procedures. Impacts to an AMF 422 (or LMF 424) may be small—e.g., such as providing pre-configured data for fixed tracking areas (TAs) and cells to a UE 405 during registration. There may be no impact to the SVs 402. The SVs 402 may be shared with other services (e.g., satellite TV, fixed Internet access) with 5G NR mobile access for UEs added in a transparent manner. This may enable legacy SVs 402 to be used and may avoid the need to deploy a new type of SV 402. Further, the base stations 406 may be fixed and may be configured to support one country and one or more PLMNs in that country. The base stations 406 may assist assignment and transfer of SVs 402 and radio cells between base stations 406 and earth stations 404 and support handover of UEs 405 between radio cells, SVs 402 and other base stations 406. Thus, the base station 406 may differ from a terrestrial gNB. Additionally, a coverage area of a base station 406 may be much larger than the coverage area of a terrestrial base station.

In some implementations, the radio beam coverage of an SV 402 may be large, e.g., up to or greater than 4000 kms across, and may provide access to more than one country. An earth station 404 may be shared by multiple base stations (e.g., earth station 404-1 may be shared by base stations 406-1 and 406-2), and a base station 406 may be shared by multiple core networks in separate PLMNs located in the same country or in different countries (e.g., base station 406-2 may be shared by CN1 410-1 and CN2 410-1, which may be in different PLMNs in the same country or in different countries).

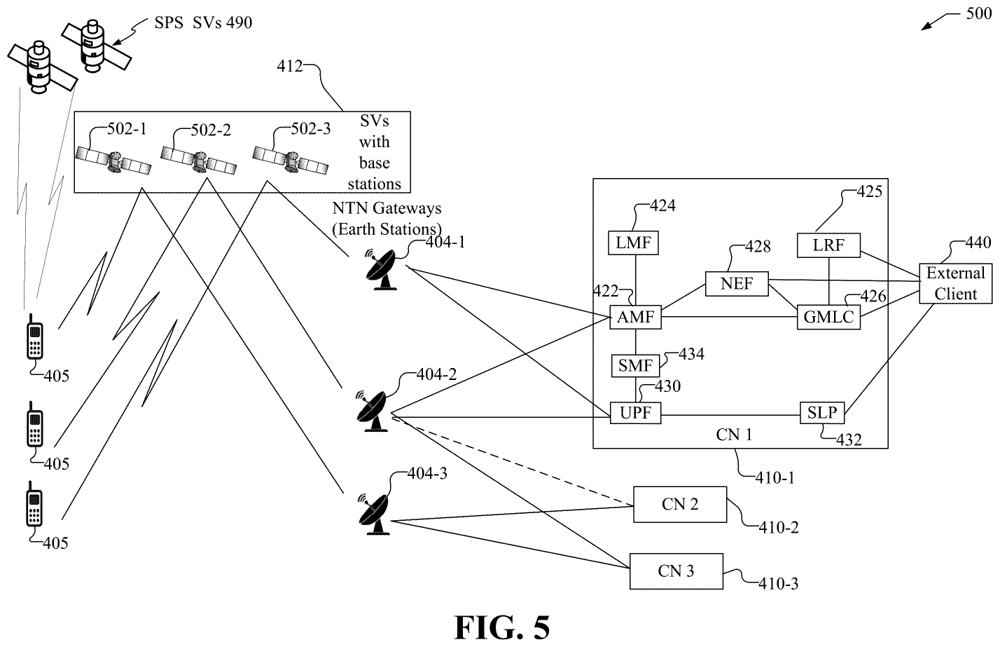

FIG. 5 shows a diagram of a network architecture 500 capable of supporting satellite access, e.g., using 5GNR. The network architecture shown in FIG. 5 is similar to that shown in FIG. 4, like designated elements being similar or the same. FIG. 5, however, illustrates a network architecture with regenerative SVs 502-1, 502-2, and 502-3 (collectively SVs 502), as opposed to transparent SVs 402 shown in FIG. 4. A regenerative SV 502, unlike a transparent SV 402, includes an on-board base station 502 (e.g., includes the functional capability of a base station), and is sometimes referred to herein as an SV/base station 502. The on-board base station 502 may correspond to the base station 310 in FIG. 3. The RAN 412 is illustrated as including the SV/base stations 502. Reference to a base station 502 is used herein when referring to SV/base station 502 functions related to communication with UEs 405 and CNs 410, whereas reference to an SV 502 is used when referring to SV/base station 502 functions related to communication with earth stations 404 and with UEs 405 at a physical radio frequency level. However, there may be no precise delimitation of an SV 502 versus a base station 502.

An onboard base station 502 may perform many of the same functions as a base station 406, as described previously. For example, a base station 502 may terminate the radio interface and associated radio interface protocols to UEs 405 and may transmit DL signals to UEs 405 and receive UL signals from UEs 405, which may include encoding and modulation of transmitted signals and demodulation and decoding of received signals. A base station 502 may also support signaling connections and voice and data bearers to UEs 405 and may support handover of UEs 405 between different radio cells for the same base station 502 and between different base stations 502. The base stations 502 may assist in the handover (or transfer) of SVs 502 between different earth stations 404, different CNs 410, and between different countries. The base stations 502 may hide or obscure specific aspects of SVs 502 from the CN 410, e.g., by interfacing to a CN 410 in the same way or in a similar way to a terrestrial base station. The base stations 502 may further assist in sharing of SVs 502 over multiple countries. The base stations 502 may communicate with one or more earth stations 404 and with one or more CNs 410 via the earth stations 404. In some implementations, base stations 502 may communicate directly with other base stations 502 using Inter-Satellite Links (ISLs) (not shown in FIG. 5), which may support an Xn interface between any pair of base stations 502.

With LEO SVs, an SV/base station 502 may manage moving radio cells with coverage in different countries at different times. Earth stations 404 may be connected directly to the CN 410, as illustrated. For example, as illustrated, earth station 404-1 may be connected to AMF 422 and UPF 430 of CN1 410-1, while earth station 404-2 may be similarly connected to CN1 410-1 through CN3 410-3, and earth station 404-3 is connected to CN2 410-2. The earth stations 404 may be shared by multiple CNs 410, for example, if earth stations 404 are limited. For example, in some implementations (illustrated with dotted lines), earth station 404-2 may be connected to all of CN1 410-1 through CN3 410-3. The CN 410 may need to be aware of SV 502 coverage areas in order to page UEs 405 and to manage handover. Thus, as can be seen, the network architecture with regenerative SVs may have more impact and complexity with respect to both base stations 502 and CNs 410 than the network architecture with transparent SVs 402 shown in FIG. 4.

Support of regenerative SVs with the network architecture shown in FIG. 5 may impact the network architecture 500 as follows. The CN 410 may be impacted if fixed TAs and fixed cells are not supported, because core components of mobility management and regulatory services, which are based on fixed cells and fixed TAs for terrestrial PLMNs, may be replaced by a new system (e.g., based on UE 405 location). If fixed TAs and fixed cells are supported, an entity in the CN 410 (e.g., the AMF 422) may map any fixed TA to one or more SVs 502 with current radio coverage of the fixed TA when performing paging of a UE 405 that is located in this fixed TA. This may result in configuration in the CN 410 of long term orbital data for SVs 502 (e.g., obtained from an SVO for SVs 502) and may add a significant new impact to a CN 410.

A new SV/base station 502 may support regulatory and other specifications for multiple countries. A GEO SV 502 coverage area may include several or many countries, whereas a LEO or medium earth orbit (MEO) SV 502 may orbit over many countries. Support of fixed TAs and fixed cells may then include an SV/base station 502 configured with fixed TAs and fixed cells for an entire worldwide coverage area. Alternatively, AMFs 422 (or LMFs 424) in individual CNs 410 may support fixed TAs and fixed cells for the associated PLMN to reduce SV/base station 502 complexity and at the expense of more 5GCN 410 complexity. Additionally, SV/base station 502 to SV/base station 502 ISLs may change dynamically as relative SV/base station 502 positions change, making Xn related procedures more complex.

Different types of UEs with significantly different uplink transmit powers may be used with an NTN. For example, a very small aperture terminal (VSAT) UE (e.g., a dish antenna) may have a transmit power of up to 5 watts (W). On the other hand, a regular smart phone UE of the power class 3 may have a transmit power of up to 200 milliwatts (mW), which is 1/25 of the transmit power of the VSAT UE described above. Therefore, while it may be relatively easy for a higher transmit power UE to properly transmit uplink signals to the satellite, it may be more difficult for a lower transmit power UE to properly transmit the uplink signals to the satellite. Hereinafter a higher transmit power UE may alternatively be referred to as a first UE, and a lower transmit power UE may alternatively be referred to as a second UE.

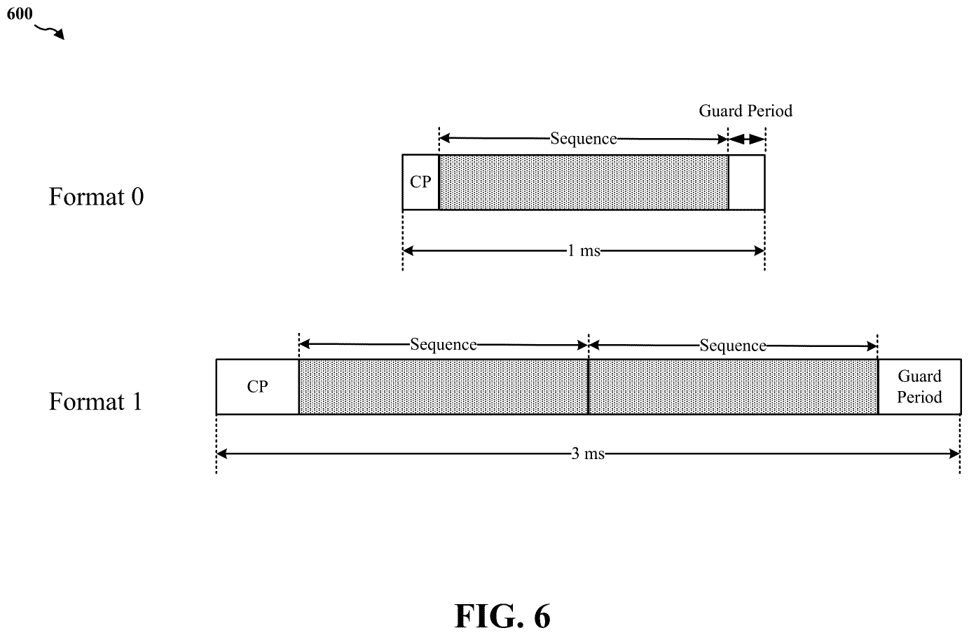

FIG. 6 is an example diagram 600 illustrating PRACH formats. A PRACH preamble may be transmitted in the uplink for random access (e.g., in a RACH procedure). A Format 0 PRACH preamble may be transmitted over 1 subframe (i.e., 1 ms), and may include a cyclic prefix (CP), a PRACH sequence (e.g., a Zadoff-Chu sequence), and a guard period. A Format 1 PRACH preamble may be transmitted over 3 subframe (i.e., 3 ms), and may include a longer CP, a PRACH sequence that is repeated twice, and a longer guard period. Therefore, the Format 1 PRACH preamble may include a built-in repetition of the PRACH sequence. However, when it comes to the RACH procedure performed by a lower transmit power UE in an NTN, even the Format 1 PRACH preamble may not include sufficient built-in PRACH sequence repetitions to close the link (e.g., to complete the RACH procedure). Accordingly, aspects described herein may advantageously relate to providing additional repetitions in the form of RO repetitions to assist the lower transmit power UEs in completing the RACH procedure.

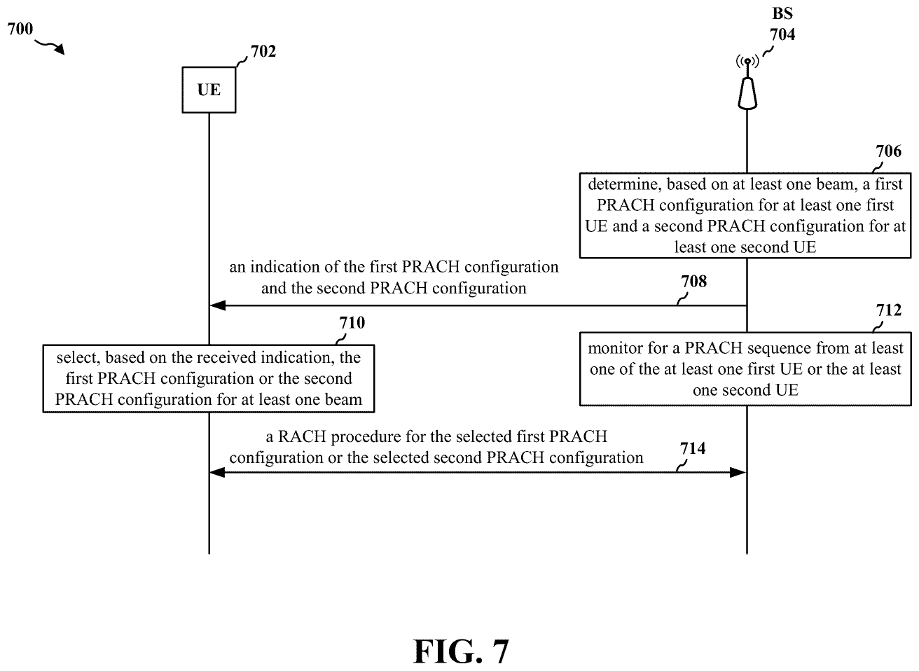

FIG. 7 is a call flow diagram 700 illustrating a method of wireless communication. The UE 702 may correspond to the UE 104 in FIG. 1, the UE 350 in FIG. 3, and the UE 405 in FIGS. 4 and 5. The base station 704 may correspond to the base station 102/180 in FIG. 1, the base station 310 in FIG. 3, the base station 406 in FIG. 4, and the base station 502 in FIG. 5. The UE 702 may be either a first UE (e.g., a higher transmit power UE) or a second UE (e.g., a lower transmit power UE). At 706, the base station 704 may determine, based on at least one beam, a first PRACH configuration for at least one first UE and a second PRACH configuration for at least one second UE. The first PRACH configuration may include a first RO configuration and a first PRACH format. The second PRACH configuration may include a second RO configuration and a second PRACH format. A beam may be identified by an SSB index, a BWP identifier (ID), or a CSI-RS identifier (CRI) associated with it.

The first RO configuration may include a first starting RO and a first repetition pattern. The second RO configuration may include a second starting RO and a second repetition pattern. It should be appreciated that a beam may be associated with a respective time and frequency resource grid for ROs. In one configuration, the ROs associated with the beam may be time division multiplexed. In another configuration, the ROs associated with the beam may be both time division multiplexed and frequency division multiplexed. Herein a repetition pattern may include a sequence of ROs over which PRACH preambles may be communicated in the uplink from the UE to the satellite in the time and frequency resource grid of ROs associated with the beam. In a first example, a repetition pattern (which may be a first repetition pattern or a second repetition pattern) may indicate a repeating of a communication of the PRACH preamble for k times (for a total of k times) over k consecutive ROs starting with a corresponding starting RO. In one configuration, the repetition pattern may also be associated with a periodicity. In other words, the repetition pattern itself may be repeated periodically based on the periodicity. In a second example, a repetition pattern (which may be a first repetition pattern or a second repetition pattern) may indicate a repeating of a communication of a PRACH preamble every m ROs (e.g., for time or frequency diversity) for k times (for a total of k times). In one configuration, the repetition pattern may also be associated with a periodicity. In case a 2-step RACH procedure is utilized, as the message A includes both a PRACH preamble and a PUSCH payload, each RO in the first RO configuration may correspond to a first PUSCH occasion (PO) and each RO in the second RO configuration corresponds to a second PO. In a further configuration, a legacy PRACH configuration where the RO repetition is not used may be utilized. The legacy PRACH configuration may be appropriate for a higher transmit power UE (i.e., a first UE). A PRACH format may indicate a PRACH preamble format, e.g., PRACH Format 0 or PRACH Format 1. For example, the first PRACH format may include a PRACH format 0 and the second PRACH format may include a PRACH format 1. A PRACH format may additionally include a set of usable PRACH sequences (e.g., the root sequence and the cyclic shift size) that a UE may choose from.

At 708, the base station 704 may transmit to the UE 702 (which may be either a first UE or a second UE), and the UE 702 may receive from the base station 704, an indication of the first PRACH configuration and the second PRACH configuration. The indication may be communicated via at least one of a broadcast message (e.g., over one or more beams) or a unicast message (e.g., in a UE handover scenario).

At 710, the UE 702 may select, based on the received indication, the first PRACH configuration or the second PRACH configuration for at least one beam. The UE 702 may select the first PRACH configuration or the second PRACH configuration based on whether the UE 702 is a first UE (i.e., a higher transmit power UE) or a second UE (i.e., a lower transmit power UE). For example, the UE 702 may select the first PRACH configuration if the UE 702 is a first UE, and may select the second PRACH configuration if the UE 702 is a second UE. In particular, the UE 702 may use a metric that may be a function of a number of factors in the selection. For example, the metric may include the reference signal received power (RSRP), which may be an indication of the channel quality of the channel between the UE 702 and the satellite. The metric may also include the uplink maximum transmit power of the UE 702, the power headroom (e.g., the available remaining power that can be used) of the UE 702, the accuracy of the autonomous timing advance and frequency offset estimation, among others. Accordingly, the metric may represent an uplink communication quality for uplink communications from the UE 702 to the satellite. Upon selection of the PRACH configuration, the UE 702 may further indicate to the network (e.g., the base station 704) the desired number of message 3 (msg3, e.g., an RRC Connection Request message) repetitions (i.e., x repetitions) to be used in a 4-step RACH procedure. The network may configure the number of msg3 repetitions, which may be the same as or different from the indicated desired number of repetitions, based at least in part on the indication. In general, the higher the uplink communication quality, the lower the number of msg3 repetitions.

In one configuration, a first UE may be associated with a first RSRP higher than a first threshold or a first maximum transmit power higher than a second threshold. A second UE may be associated with a second RSRP lower than the first threshold or a second maximum transmit power lower than the second threshold. Accordingly, the UE 702 may select the first PRACH configuration or the second PRACH configuration based on whether an RSRP is higher or lower than the first threshold, or based on whether a maximum transmit power of the UE 702 is higher or lower than a second threshold. For example, the UE 702 may select the first PRACH configuration if the RSRP is higher than the first threshold, and may select the second PRACH configuration if the RSRP is lower than the first threshold. In another configuration, the UE 702 may select the first PRACH configuration if the maximum transmit power is higher than the second threshold, and may select the second PRACH configuration if the maximum transmit power is lower than the second threshold. On a further configuration, the UE 702 may select the first PRACH configuration or the second PRACH configuration taking into consideration both the RSRP and the maximum transmit power.

In one configuration, a msg3 may be repeated a first number of times during a 4-step RACH procedure of a first UE, and a msg3 may be repeated a second number of times during a 4-step RACH procedure of a second UE. The first number of times may be less than a third threshold. The second number of times may be greater than the third threshold. Accordingly, the UE 702 may select the first PRACH configuration or the second PRACH configuration based on whether a number of times a msg3 is to be repeated during the 4-step RACH procedure is greater than or less than a third threshold. For example, the UE 702 may select the first PRACH configuration if the number of times the msg3 is to be repeated during the 4-step RACH procedure is less than the third threshold, and may select the second PRACH configuration if the number of times the msg3 is to be repeated during the 4-step RACH procedure is greater than the third threshold.

At 712, the base station 704 may monitor, via the at least one beam, for a PRACH sequence from at least one of the at least one first UE or the at least one second UE (e.g., the UE 702).

At 714, the UE 702 may initiate, via the at least one beam, a RACH procedure for the selected first PRACH configuration or the selected second PRACH configuration. In particular, the UE 702 may transmit one or more PRACH preambles based on the RO configuration and the PRACH format associated with the selected PRACH configuration. The RACH procedure may be a 2-step RACH procedure or a 4-step RACH procedure. In case of a 4-step RACH procedure, a msg3 may be repeated during the RACH procedure, as described above. In case of a 2-step RACH procedure, as the message A includes both a PRACH preamble and a PUSCH payload, eachRO may correspond to a PO.

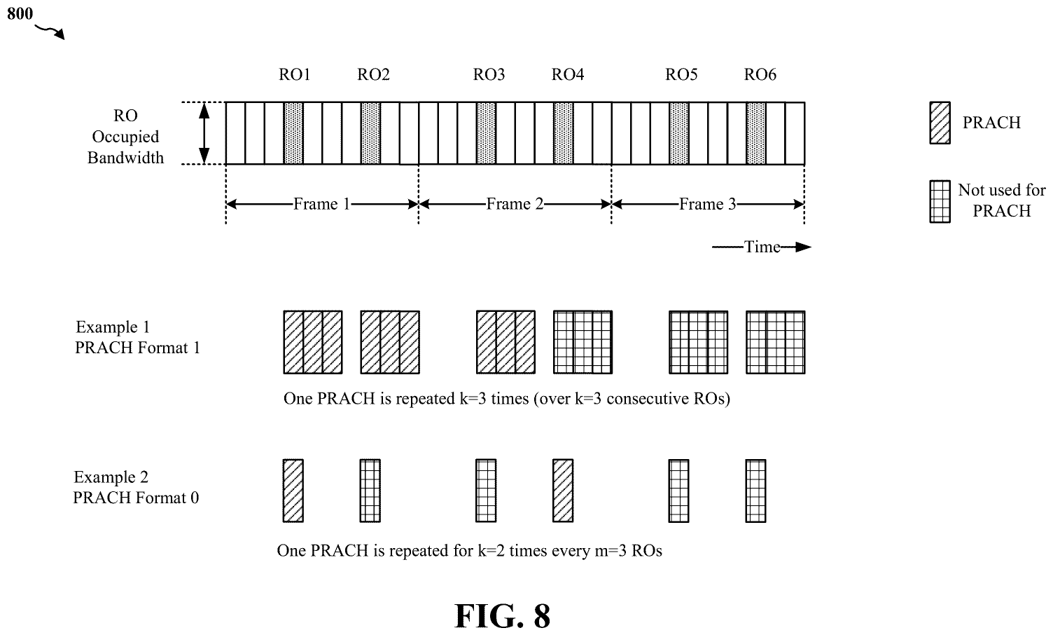

FIG. 8 is a diagram 800 illustrating examples of RACH occasion repetition and PRACH format configuration. In FIG. 8, three frames (Frames 1 to 3), each of which may include 10 subframes, are illustrated. The ROs (RO1 through RO6) for the beam may be time division multiplexed. RO1 may be the starting RO, followed by RO2, RO3, etc. In the illustrated Example 1, PRACH Format 1 may be utilized. Each PRACH preamble according to the PRACH Format 1 may span three subframes. The repetition pattern may indicate a repeating of the communication of the PRACH preamble for k=3 times over k=3 consecutive ROs starting with the starting RO. Accordingly, the PRACH preamble in Format 1 may be repeated 3 times over RO1 through RO3. In the illustrated Example 2, PRACH Format 0 may be utilized. Each PRACH preamble according to the PRACH Format 0 may span one subframe. The repetition pattern may indicate a repeating of the communication of the PRACH preamble every m=3 ROs for 1-2 times. Accordingly, the PRACH preamble in Format 0 may be repeated 2 times over RO1 and RO4.

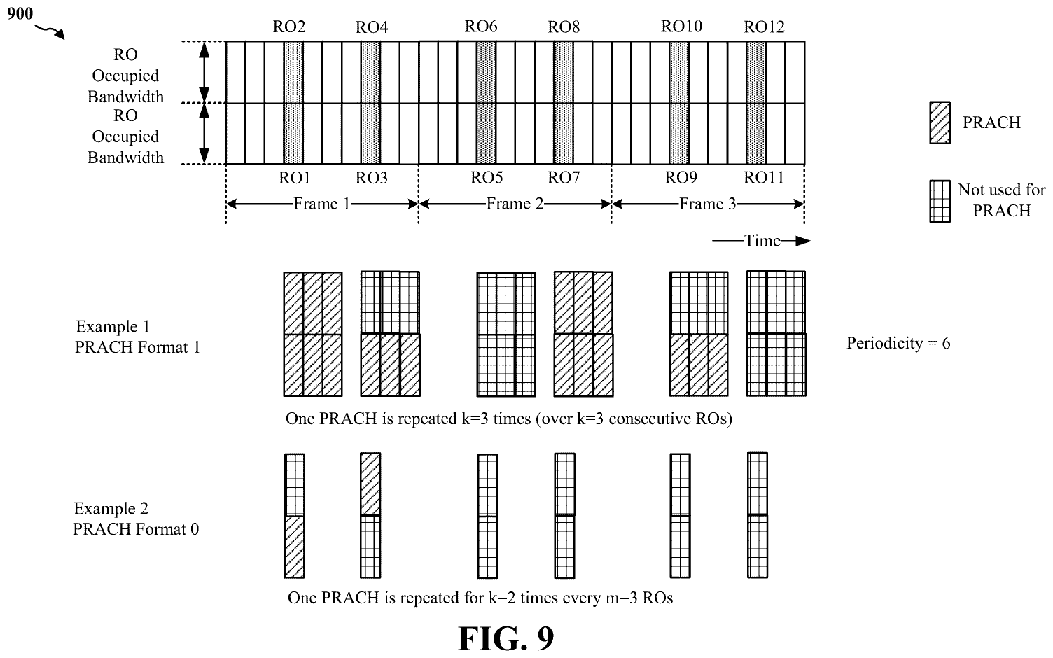

FIG. 9 is a diagram 900 illustrating examples of RACH occasion repetition and PRACH format configuration. In FIG. 9, three frames (Frames 1 to 3), each of which may include 10 subframes, are illustrated. The ROs (RO1 through RO12) for the beam may be both time division multiplexed and frequency division multiplexed. RO1 may be the starting RO, followed by RO2, RO3, etc. In the illustrated Example 1, PRACH Format 1 may be utilized. Each PRACH preamble according to the PRACH Format 1 may span three subframes. The repetition pattern may indicate a repeating of the communication of the PRACH preamble for k=3 times over k=3 consecutive ROs starting with the starting RO. Accordingly, the PRACH preamble in Format 1 may be repeated 3 times over RO1 through RO3. The PRACH configuration in this example may also indicate a periodicity of 6. In other words, the repetition pattern itself may be repeated every 6 ROs. Accordingly, the PRACH preamble in Format 1 may be repeated again 3 times over RO7 through RO9. In the illustrated Example 2, PRACH Format 0 may be utilized. Each PRACH preamble according to the PRACH Format 0 may span one subframe. The repetition pattern may indicate a repeating of the communication of the PRACH preamble every m=3 ROs for 1-2 times. Accordingly, the PRACH preamble in Format 0 may be repeated 2 times over RO1 and RO4.

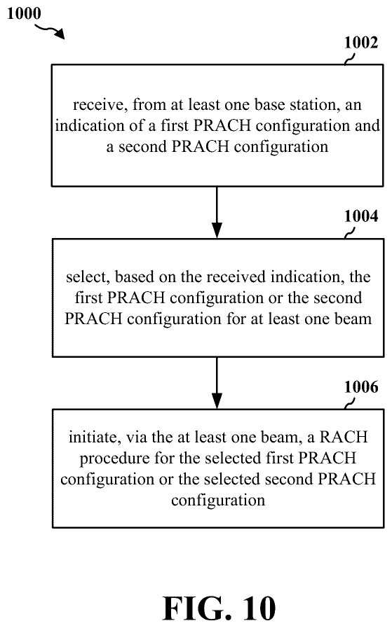

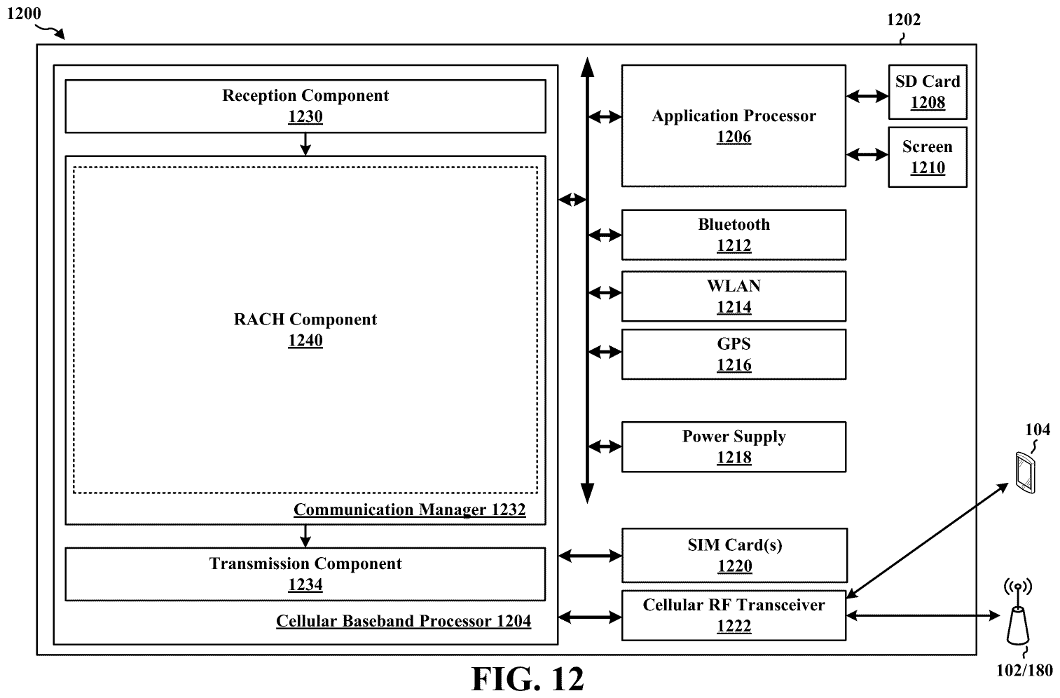

FIG. 10 is a flowchart 1000 of a method of wireless communication. The method may be performed by a UE (e.g., the UE 104/350/405/702; the apparatus 1202). At 1002, the UE may receive, from at least one base station, an indication of a first PRACH configuration and a second PRACH configuration. The first PRACH configuration may include a first RO configuration and a first PRACH format. The second PRACH configuration may include a second RO configuration and a second PRACH format. For example, 1002 may be performed by the RACH component 1240 in FIG. 12. Referring to FIG. 7, at 708, the UE 702 may receive, from at least one base station, an indication of a first PRACH configuration and a second PRACH configuration.

At 1004, the UE may select, based on the received indication, the first PRACH configuration or the second PRACH configuration for at least one beam. For example, 1004 may be performed by the RACH component 1240 in FIG. 12. Referring to FIG. 7, at 710, the UE 702 may select, based on the received indication, the first PRACH configuration or the second PRACH configuration for at least one beam.

At 1006, the UE may initiate, via the at least one beam, a RACH procedure for the selected first PRACH configuration or the selected second PRACH configuration. For example, 1006 may be performed by the RACH component 1240 in FIG. 12. Referring to FIG. 7, at 714, the UE 702 may initiate, via the at least one beam, a RACH procedure for the selected first PRACH configuration or the selected second PRACH configuration.

In one configuration, the first RO configuration may include a first starting RO and a first repetition pattern, and the second RO configuration may include a second starting RO and a second repetition pattern.

In one configuration, at least one of the first repetition pattern or the second repetition pattern may indicate repeating a communication of a PRACH preamble k times over k consecutive ROs starting with a corresponding starting RO and a first periodicity. In one configuration, at least one of the first repetition pattern or the second repetition pattern may indicate repeating a communication of a PRACH preamble every m ROs for k times and a second periodicity.

In one configuration, each RO in the first RO configuration may correspond to a first PO and each RO in the second RO configuration may correspond to a second PO.

In one configuration, at least one of the first RO configuration or the second RO configuration may include one or more ROs within one or more time division multiplexed time-frequency resources. In one configuration, the one or more time division multiplexed time-frequency resources may be frequency division multiplexed.

In one configuration, the first PRACH format may include a PRACH format 0 and the second PRACH format may include a PRACH format 1. In one configuration, at least one of the first PRACH format or the second PRACH format may further include a set of usable PRACH sequences.

In one configuration, the indication may be received via at least one of a broadcast message or a unicast message.

In one configuration, the UE may select the first PRACH configuration or the second PRACH configuration based on whether an RSRP is higher or lower than a first threshold, or based on whether a maximum transmit power of the UE is higher or lower than a second threshold. In one configuration, the UE may select the first PRACH configuration or the second PRACH configuration based on whether a number of times a msg3 is repeated during the RACH procedure is greater than or less than a third threshold.

In one configuration, the RACH procedure may include a 2-step RACH procedure or a 4-step RACH procedure. In one configuration, the RACH procedure may include the 4-step RACH procedure, and a msg3 may be repeated during the RACH procedure.

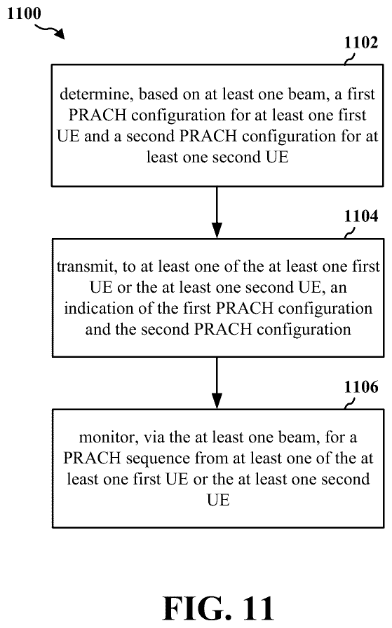

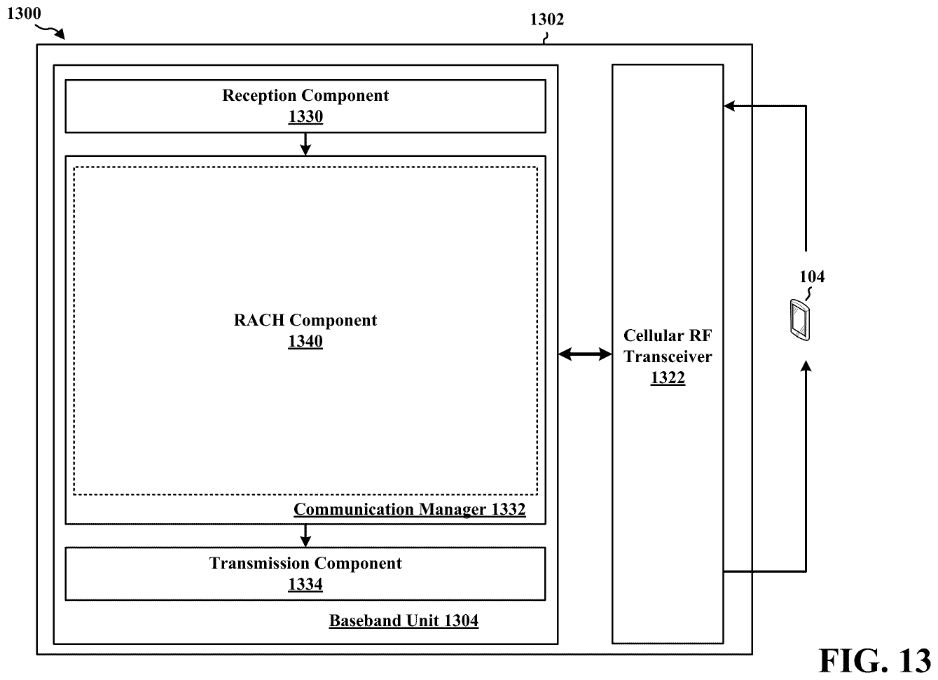

FIG. 11 is a flowchart 1100 of a method of wireless communication. The method may be performed by a base station (e.g., the base station 102/180/310/406/502/704; the apparatus 1302). At 1102, the base station may determine, based on at least one beam, a first PRACH configuration for at least one first UE and a second PRACH configuration for at least one second UE. The first PRACH configuration may include a first RO configuration and a first PRACH format. The second PRACH configuration may include a second RO configuration and a second PRACH format. For example, 1102 may be performed by the RACH component 1340 in FIG. 13. Referring to FIG. 7, at 706, the base station 704 may determine, based on at least one beam, a first PRACH configuration for at least one first UE and a second PRACH configuration for at least one second UE.

At 1104, the base station may transmit, to at least one of the at least one first UE or the at least one second UE, an indication of the first PRACH configuration and the second PRACH configuration. For example, 1104 may be performed by the RACH component 1340 in FIG. 13. Referring to FIG. 7, at 708, the base station 704 may transmit, to at least one of the at least one first UE 702 or the at least one second UE 702, an indication of the first PRACH configuration and the second PRACH configuration.

At 1106, the base station may monitor, via the at least one beam, for a PRACH sequence from at least one of the at least one first UE or the at least one second UE. For example, 1106 may be performed by the RACH component 1340 in FIG. 13. Referring to FIG. 7, at 712, the base station 704 may monitor, via the at least one beam, for a PRACH sequence from at least one of the at least one first UE or the at least one second UE.

In one configuration, the first RO configuration may include a first starting RO and a first repetition pattern, and the second RO configuration may include a second starting RO and a second repetition pattern.

In one configuration, at least one of the first repetition pattern or the second repetition pattern may indicate repeating a communication of a PRACH preamble for k times over k consecutive ROs starting with a corresponding starting RO and a first periodicity. In one configuration, at least one of the first repetition pattern or the second repetition pattern may indicate repeating a communication of a PRACH preamble every m ROs for k times and a second periodicity.

In one configuration, each RO in the first RO configuration may correspond to a first PO and each RO in the second RO configuration may correspond to a second PO.

In one configuration, at least one of the first RO configuration or the second RO configuration may include one or more ROs within one or more time division multiplexed time-frequency resources. In one configuration, the one or more time division multiplexed time-frequency resources may be frequency division multiplexed.

In one configuration, the first PRACH format may include a PRACH format 0 and the second PRACH format includes a PRACH format 1. In one configuration, at least one of the first PRACH format or the second PRACH format may further include a set of usable PRACH sequences.

In one configuration, the at least one first UE may be associated with a first RSRP higher than a first threshold or a first maximum transmit power higher than a second threshold. The at least one second UE may be associated with a second RSRP lower than the first threshold or a second maximum transmit power lower than the second threshold. In one configuration, a msg3 may be repeated a first number of times during a RACH procedure of the at least one first UE, and a msg3 may be repeated a second number of times during a RACH procedure of the at least one second UE. The first number of times may be less than a third threshold. The second number of times may be greater than the third threshold.

In one configuration, the indication may be transmitted via at least one of a broadcast message or a unicast message.

In one configuration, the at least one beam may be associated with at least one of an SSB index, a BWP ID, or a CRI.

FIG. 12 is a diagram 1200 illustrating an example of a hardware implementation for an apparatus 1202. The apparatus 1202 is a UE and includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the aforediscussed additional modules of the apparatus 1202.

The communication manager 1232 includes a RACH component 1240 that is configured to receive, from at least one base station, an indication of a first PRACH configuration and a second PRACH configuration, e.g., as described in connection with 1002 in FIG. 10. The first PRACH configuration may include a first RO configuration and a first PRACH format. The second PRACH configuration may include a second RO configuration and a second PRACH format. The RACH component 1240 may be further configured to select, based on the received indication, the first PRACH configuration or the second PRACH configuration for at least one beam, e.g., as described in connection with 1004 in FIG. 10. The RACH component 1240 may be further configured to initiate, via the at least one beam, a RACH procedure for the selected first PRACH configuration or the selected second PRACH configuration, e.g., as described in connection with 1006 in FIG. 10.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for receiving, from at least one base station, an indication of a first PRACH configuration and a second PRACH configuration. The first PRACH configuration may include a first RO configuration and a first PRACH format. The second PRACH configuration may include a second RO configuration and a second PRACH format. The apparatus 1202, and in particular the cellular baseband processor 1204, may further include means for selecting, based on the received indication, the first PRACH configuration or the second PRACH configuration for at least one beam. The apparatus 1202, and in particular the cellular baseband processor 1204, may further include means for initiating, via the at least one beam, a RACH procedure for the selected first PRACH configuration or the selected second PRACH configuration.

In one configuration, the first RO configuration may include a first starting RO and a first repetition pattern, and the second RO configuration may include a second starting RO and a second repetition pattern. In one configuration, at least one of the first repetition pattern or the second repetition pattern may indicate repeating a communication of a PRACH preamble k times over k consecutive ROs starting with a corresponding starting RO and a first periodicity. In one configuration, at least one of the first repetition pattern or the second repetition pattern may indicate repeating a communication of a PRACH preamble every m ROs for k times and a second periodicity. In one configuration, each RO in the first RO configuration may correspond to a first PO and each RO in the second RO configuration may correspond to a second PO. In one configuration, at least one of the first RO configuration or the second RO configuration may include one or more ROs within one or more time division multiplexed time-frequency resources. In one configuration, the one or more time division multiplexed time-frequency resources may be frequency division multiplexed. In one configuration, the first PRACH format may include a PRACH format 0 and the second PRACH format may include a PRACH format 1. In one configuration, at least one of the first PRACH format or the second PRACH format may further include a set of usable PRACH sequences. In one configuration, the indication may be received via at least one of a broadcast message or a unicast message. In one configuration, the UE may select the first PRACH configuration or the second PRACH configuration based on whether an RSRP is higher or lower than a first threshold, or based on whether a maximum transmit power of the UE is higher or lower than a second threshold. In one configuration, the UE may select the first PRACH configuration or the second PRACH configuration based on whether a number of times a msg3 is repeated during the RACH procedure is greater than or less than a third threshold. In one configuration, the RACH procedure may include a 2-step RACH procedure or a 4-step RACH procedure. In one configuration, the RACH procedure may include the 4-step RACH procedure, and a msg3 may be repeated during the RACH procedure.

The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 13 is a diagram 1300 illustrating an example of a hardware implementation for an apparatus 1302. The apparatus 1302 is a BS and includes a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 310 and may include the memory 376 and/or at least one of the TX processor 316, the RX processor 370, and the controller/processor 375.

The communication manager 1332 includes a RACH component 1340 that may be configured to determine, based on at least one beam, a first PRACH configuration for at least one first UE and a second PRACH configuration for at least one second UE, e.g., as described in connection with 1102 in FIG. 11. The first PRACH configuration may include a first RO configuration and a first PRACH format. The second PRACH configuration may include a second RO configuration and a second PRACH format. The RACH component 1340 may be further configured to transmit, to at least one of the at least one first UE or the at least one second UE, an indication of the first PRACH configuration and the second PRACH configuration, e.g., as described in connection with 1104 in FIG. 11. The RACH component 1340 may be further configured to monitor, via the at least one beam, for a PRACH sequence from at least one of the at least one first UE or the at least one second UE, e.g., as described in connection with 1106 in FIG. 11.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for determining, based on at least one beam, a first PRACH configuration for at least one first UE and a second PRACH configuration for at least one second UE. The first PRACH configuration may include a first RO configuration and a first PRACH format. The second PRACH configuration may include a second RO configuration and a second PRACH format. The apparatus 1302, and in particular the baseband unit 1304, may further include means for transmitting, to at least one of the at least one first UE or the at least one second UE, an indication of the first PRACH configuration and the second PRACH configuration. The apparatus 1302, and in particular the baseband unit 1304, may further include means for monitoring, via the at least one beam, for a PRACH sequence from at least one of the at least one first UE or the at least one second UE.

In one configuration, the first RO configuration may include a first starting RO and a first repetition pattern, and the second RO configuration may include a second starting RO and a second repetition pattern. In one configuration, at least one of the first repetition pattern or the second repetition pattern may indicate repeating a communication of a PRACH preamble for k times over k consecutive ROs starting with a corresponding starting RO and a first periodicity. In one configuration, at least one of the first repetition pattern or the second repetition pattern may indicate repeating a communication of a PRACH preamble every m ROs for k times and a second periodicity. In one configuration, each RO in the first RO configuration may correspond to a first PO and each RO in the second RO configuration may correspond to a second PO. In one configuration, at least one of the first RO configuration or the second RO configuration may include one or more ROs within one or more time division multiplexed time-frequency resources. In one configuration, the one or more time division multiplexed time-frequency resources may be frequency division multiplexed. In one configuration, the first PRACH format may include a PRACH format 0 and the second PRACH format includes a PRACH format 1. In one configuration, at least one of the first PRACH format or the second PRACH format may further include a set of usable PRACH sequences. In one configuration, the at least one first UE may be associated with a first RSRP higher than a first threshold or a first maximum transmit power higher than a second threshold. The at least one second UE may be associated with a second RSRP lower than the first threshold or a second maximum transmit power lower than the second threshold. In one configuration, a msg3 may be repeated a first number of times during a RACH procedure of the at least one first UE, and a msg3 may be repeated a second number of times during a RACH procedure of the at least one second UE. The first number of times may be less than a third threshold. The second number of times may be greater than the third threshold. In one configuration, the indication may be transmitted via at least one of a broadcast message or a unicast message. In one configuration, the at least one beam may be associated with at least one of an SSB index, a BWP ID, or a CRI.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

As described above, the base station may determine, based on at least one beam, a first PRACH configuration for at least one first UE and a second PRACH configuration for at least one second UE. The first PRACH configuration may include a first RO configuration and a first PRACH format. The second PRACH configuration may include a second RO configuration and a second PRACH format. The base station may transmit, to at least one of the at least one first UE or the at least one second UE, an indication of the first PRACH configuration and the second PRACH configuration. The base station may monitor, via the at least one beam, for a PRACH sequence from at least one of the at least one first UE or the at least one second UE. The UE, based on whether it is a first UE or a second UE, may select, based on the received indication, the first PRACH configuration or the second PRACH configuration for at least one beam. The UE may initiate, via the at least one beam, a RACH procedure for the selected first PRACH configuration or the selected second PRACH configuration. Accordingly, sufficient RO repetitions may be provided to enable lower transmit power devices to close the link when performing a RACH procedure over satellite communication in an NTN.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a base station, including: determining, based on at least one beam, a first PRACH configuration for at least one first UE and a second PRACH configuration for at least one second UE, the first PRACH configuration including a first RO configuration and a first PRACH format, the second PRACH configuration including a second RO configuration and a second PRACH format; transmitting, to at least one of the at least one first UE or the at least one second UE, an indication of the first PRACH configuration and the second PRACH configuration; and monitoring, via the at least one beam, for a PRACH sequence from at least one of the at least one first UE or the at least one second UE.

Aspect 2 is the method of aspect 1, where the first RO configuration includes a first starting RO and a first repetition pattern, and the second RO configuration includes a second starting RO and a second repetition pattern.

Aspect 3 is the method of aspect 2, where at least one of the first repetition pattern or the second repetition pattern indicates repeating a communication of a PRACH preamble for k times over k consecutive ROs starting with a corresponding starting RO and a first periodicity.

Aspect 4 is the method of aspect 2, where at least one of the first repetition pattern or the second repetition pattern indicates repeating a communication of a PRACH preamble every m ROs for k times and a second periodicity.

Aspect 5 is the method of any of aspects 2 to 4, where each RO in the first RO configuration corresponds to a first PO and each RO in the second RO configuration corresponds to a second PO.

Aspect 6 is the method of any of aspects 1 to 5, where at least one of the first RO configuration or the second RO configuration includes one or more ROs within one or more time division multiplexed time-frequency resources.

Aspect 7 is the method of aspect 6, where the one or more time division multiplexed time-frequency resources are frequency division multiplexed.

Aspect 8 is the method of any of aspects 1 to 7, where the first PRACH format includes aPRACHformat 0 and the second PRACH format includes a PRACH format 1.

Aspect 9 is the method of aspect 8, where at least one of the first PRACH format or the second PRACH format further includes a set of usable PRACH sequences.

Aspect 10 is the method of any of aspects 1 to 9, where the at least one first UE is associated with a first RSRP higher than a first threshold or a first maximum transmit power higher than a second threshold, and where the at least one second UE is associated with a second RSRP lower than the first threshold or a second maximum transmit power lower than the second threshold.

Aspect 11 is the method of any of aspects 1 to 10, where a msg3 is repeated a first number of times during a RACH procedure of the at least one first UE, and a msg3 is repeated a second number of times during a RACH procedure of the at least one second UE, the first number of times being less than a third threshold, the second number of times being greater than the third threshold.

Aspect 12 is the method of any of aspects 1 to 11, where the indication is transmitted via at least one of a broadcast message or a unicast message.

Aspect 13 is the method of any of aspects 1 to 12, where the at least one beam is associated with at least one of an SSB index, a BWP ID, or a CRI.

Aspect 14 is a method of wireless communication at a UE, including: receiving, from at least one base station, an indication of a first PRACH configuration and a second PRACH configuration, the first PRACH configuration including a first RO configuration and a first PRACH format, the second PRACH configuration including a second RO configuration and a second PRACH format; selecting, based on the received indication, the first PRACH configuration or the second PRACH configuration for at least one beam; and initiating, via the at least one beam, a RACH procedure for the selected first PRACH configuration or the selected second PRACH configuration.

Aspect 15 is the method of aspect 14, where the first RO configuration includes a first starting RO and a first repetition pattern, and the second RO configuration includes a second starting RO and a second repetition pattern.

Aspect 16 is the method of aspect 15, where at least one of the first repetition pattern or the second repetition pattern indicates repeating a communication of a PRACH preamble k times over k consecutive ROs starting with a corresponding starting RO and a first periodicity.

Aspect 17 is the method of aspect 15, where at least one of the first repetition pattern or the second repetition pattern indicates repeating a communication of a PRACH preamble every m ROs for k times and a second periodicity.

Aspect 18 is the method of any of aspects 15 to 17, where each RO in the first RO configuration corresponds to a first PO and each RO in the second RO configuration corresponds to a second PO.

Aspect 19 is the method of any of aspects 14 to 18, where at least one of the first RO configuration or the second RO configuration includes one or more ROs within one or more time division multiplexed time-frequency resources.

Aspect 20 is the method of aspect 19, where the one or more time division multiplexed time-frequency resources are frequency division multiplexed.

Aspect 21 is the method of any of aspects 14 to 20, where the first PRACH format includes aPRACHformat 0 and the second PRACH format includes a PRACH format 1.

Aspect 22 is the method of aspect 21, where at least one of the first PRACH format or the second PRACH format further includes a set of usable PRACH sequences.

Aspect 23 is the method of any of aspects 14 to 22, where the indication is received via at least one of a broadcast message or a unicast message.

Aspect 24 is the method of any of aspects 14 to 23, where the UE selects the first PRACH configuration or the second PRACH configuration based on whether an RSRP is higher or lower than a first threshold, or based on whether a maximum transmit power of the UE is higher or lower than a second threshold.

Aspect 25 is the method of any of aspects 14 to 24, where the UE selects the first PRACH configuration or the second PRACH configuration based on whether a number of times a msg3 is repeated during the RACH procedure is greater than or less than a third threshold.

Aspect 26 is the method of any of aspects 14 to 25, where the RACH procedure includes a 2-step RACH procedure or a 4-step RACH procedure.

Aspect 27 is the method of aspect 26, where the RACH procedure includes the 4-step RACH procedure, and a msg3 is repeated during the RACH procedure.

Aspect 28 is an apparatus for wireless communication including at least one processor coupled to a memory and configured to implement a method as in any of aspects 1 to 27.

Aspect 29 is an apparatus for wireless communication including means for implementing a method as in any of aspects 1 to 27.

Aspect 30 is a computer-readable medium storing computer executable code, where the code when executed by a processor causes the processor to implement a method as in any of aspects 1 to 27.

What is claimed is:

1. An apparatus for wireless communication at abase station, comprising:
a memory; and
at least one processor coupled to the memory and configured to:
determine, based on at least one beam, a first physical random access channel (PRACH) configuration for at least one first user equipment (UE) and a second PRACH configuration for at least one second UE, the first PRACH configuration including a first random access channel (RACH) occasion (RO) configuration and a first PRACH format, the second PRACH configuration including a second RO configuration and a second PRACH format;
transmit, to at least one of the at least one first UE or the at least one second UE, an indication of the first PRACH configuration and the second PRACH configuration; and
monitor, via the at least one beam, for a PRACH sequence from at least one of the at least one first UE or the at least one second UE.

2. The apparatus of claim 1, wherein the first RO configuration includes a first starting RO and a first repetition pattern, and the second RO configuration includes a second starting RO and a second repetition pattern.

3. The apparatus of claim 2, wherein at least one of the first repetition pattern or the second repetition pattern indicates repeating a communication of a PRACH preamble for k times over k consecutive ROs starting with a corresponding starting RO and a first periodicity.

4. The apparatus of claim 2, wherein at least one of the first repetition pattern or the second repetition pattern indicates repeating a communication of a PRACH preamble every m ROs for k times and a second periodicity.

5. The apparatus of claim 2, wherein each RO in the first RO configuration corresponds to a first physical uplink shared channel (PUSCH) occasion (PO) and each RO in the second RO configuration corresponds to a second PO.

6. The apparatus of claim 1, wherein at least one of the first RO configuration or the second RO configuration includes one or more ROs within one or more time division multiplexed time-frequency resources.

7. The apparatus of claim 6, wherein the one or more time division multiplexed time-frequency resources are frequency division multiplexed.

8. The apparatus of claim 1, wherein the first PRACH format includes a PRACH format 0 and the second PRACH format includes a PRACH format 1.

9. The apparatus of claim 8, wherein at least one of the first PRACH format or the second PRACH format further includes a set of usable PRACH sequences.

10. The apparatus of claim 1, wherein the at least one first UE is associated with a first reference signal received power (RSRP) higher than a first threshold or a first maximum transmit power higher than a second threshold, and wherein the at least one second UE is associated with a second RSRP lower than the first threshold or a second maximum transmit power lower than the second threshold.

11. The apparatus of claim 1, wherein a message 3 (msg3) is repeated a first number of times during a RACH procedure of the at least one first UE, and a msg3 is repeated a second number of times during a RACH procedure of the at least one second UE, the first number of times being less than a third threshold, the second number of times being greater than the third threshold.

12. The apparatus of claim 1, wherein the indication is transmitted via at least one of a broadcast message or a unicast message.

13. The apparatus of claim 1, wherein the at least one beam is associated with at least one of a synchronization signal block (SSB) index, a bandwidth part (BWP) identifier (ID), or a channel state information (CSI)-reference signal (RS) (CSI-RS) identifier (CRI).

14. A method of wireless communication at a base station, comprising:
determining, based on at least one beam, a first physical random access channel (PRACH) configuration for at least one first user equipment (UE) and a second PRACH configuration for at least one second UE, the first PRACH configuration including a first random access channel (RACH) occasion (RO) configuration and a first PRACH format, the second PRACH configuration including a second RO configuration and a second PRACH format;
transmitting, to at least one of the at least one first UE or the at least one second UE, an indication of the first PRACH configuration and the second PRACH configuration; and
monitoring, via the at least one beam, for a PRACH sequence from at least one of the at least one first UE or the at least one second UE.

15. The method of claim 14, wherein the first RO configuration includes a first starting RO and a first repetition pattern, and the second RO configuration includes a second starting RO and a second repetition pattern.

16. An apparatus for wireless communication at a user equipment (UE), comprising:
a memory; and
at least one processor coupled to the memory and configured to:
receive, from at least one base station, an indication of a first physical random access channel (PRACH) configuration and a second PRACH configuration, the first PRACH configuration including a first random access channel (RACH) occasion (RO) configuration and a first PRACH format, the second PRACH configuration including a second RO configuration and a second PRACH format;
select, based on the received indication, the first PRACH configuration or the second PRACH configuration for at least one beam; and
initiate, via the at least one beam, a RACH procedure for the selected first PRACH configuration or the selected second PRACH configuration.

17. The apparatus of claim 16, wherein the first RO configuration includes a first starting RO and a first repetition pattern, and the second RO configuration includes a second starting RO and a second repetition pattern.

18. The apparatus of claim 17, wherein at least one of the first repetition pattern or the second repetition pattern indicates repeating a communication of a PRACH preamble for k times over k consecutive ROs starting with a corresponding starting RO and a first periodicity.

19. The apparatus of claim 17, wherein at least one of the first repetition pattern or the second repetition pattern indicates repeating a communication of a PRACH preamble every m ROs for k times and a second periodicity.

20. The apparatus of claim 17, wherein eachRO in the first RO configuration corresponds to a first physical uplink shared channel (PUSCH) occasion (PO) and each RO in the second RO configuration corresponds to a second PO.

21. The apparatus of claim 16, wherein at least one of the first RO configuration or the second RO configuration includes one or more ROs within one or more time division multiplexed time-frequency resources.

22. The apparatus of claim 21, wherein the one or more time division multiplexed time-frequency resources are frequency division multiplexed.

23. The apparatus of claim 16, wherein the first PRACH format includes aPRACHformat 0 and the second PRACH format includes a PRACH format 1.

24. The apparatus of claim 23, wherein at least one of the first PRACH format or the second PRACH format further includes a set of usable PRACH sequences.

25. The apparatus of claim 16, wherein the indication is received via at least one of a broadcast message or a unicast message.

26. The apparatus of claim 16, wherein the UE selects the first PRACH configuration or the second PRACH configuration based on whether a reference signal received power (RSRP) is higher or lower than a first threshold, or based on whether a maximum transmit power of the UE is higher or lower than a second threshold.

27. The apparatus of claim 16, wherein the UE selects the first PRACH configuration or the second PRACH configuration based on whether a number of times a message 3 (msg3) is repeated during the RACH procedure is greater than or less than a third threshold.

28. The apparatus of claim 16, wherein the RACH procedure includes a 2-step RACH procedure or a 4-step RACH procedure.

29. The apparatus of claim 28, wherein the RACH procedure includes the 4-step RACH procedure, and a message 3 (msg3) is repeated during the RACH procedure.

30. A method of wireless communication at a user equipment (UE), comprising:
receiving, from at least one base station, an indication of a first physical random access channel (PRACH) configuration and a second PRACH configuration, the first PRACH configuration including a first random access channel (RACH) occasion (RO) configuration and a first PRACH format, the second PRACH configuration including a second RO configuration and a second PRACH format;
selecting, based on the received indication, the first PRACH configuration or the second PRACH configuration for at least one beam; and
initiating, via the at least one beam, a RACH procedure for the selected first PRACH configuration or the selected second PRACH configuration.
